(19) United States
(12) Patent Application Publication
(10) Pub. No.: US 2025/0130078 A1
(43) Pub. Date: Apr. 24, 2025

(54) Display Unit for a Measuring Device for Process and Automation Technology and Measuring Device for Process and Automation Technology

(71) Applicant: IFM Electronic GmbH, Essen (DE)

(72) Inventors: Patrick Werner, Stetten (DE); Marc Doehring, Aulendorf (DE)

(73) Assignee: IFM Electronic GmbH, Essen (DE)

(21) Appl. No.: 18/832,368

(22) PCT Filed: Jan. 24, 2023
(86) PCT No.: PCT/EP2023/051638

§ 371 Date: Jul. 23, 2024

(30) Foreign Application Priority Data
Jan. 28, 2022 (DE) 10 2022 102 071.1

(51) Int. Cl. G01D 11/26

(52) U.S. Cl. CPC G01D 11/26

(57) ABSTRACT

The invention relates to a display unit for a measuring device, comprising a housing (10) with an opening (11) for a display (2). The display (2) is covered by a front panel (20), and a molded seal (30) with a bead-type main part (31) and a seal lip (32) is arranged between the housing (10) and the front panel (20), said seal lip being formed by two limbs which are arranged at an angle to each other and having a shape which complements the contour of the recess of the front panel (20). The bead-type main part (31) is arranged between the inner face of the housing (10) and the front panel (20) in order to achieve a pressing or holding function for the front panel (20), and the seal lip (32) extends into the free area (3) between the housing (10) and the front panel (20) in order to achieve a radial seal effect, wherein the front panel (20) is set back relative to the surface of the housing (10), and the housing (10) inner edge which covers the recess (21) of the front panel (20) has an embossed section (12) in the vertical direction of the front panel (20).

The invention relates to a display unit for a measuring device for process and automation technology according to the preamble of claim 1 and to a measuring device for process and automation technology comprising such a display unit.

In automation and process technology, sensors or measuring devices are often used which convert the detected measured value—e.g. pressure, temperature, flow rate, but also distance or vibration—into an output signal representing this measured value in the form of an analog or digital current or voltage signal and provide this signal at their cable or plug connection, but sometimes also wirelessly, to a higher-level control unit, e.g. a PLC, for further processing.

A typical measuring device first of all consists of a sensor element, also known as a transducer, which serves to detect and convert a physical measured variable of a process value into a measurement signal. Furthermore, an evaluation unit is provided, which is often configured as a microcontroller and in which the measurement signals generated by the sensor element are prepared, i.e. amplified, and usually also processed. The evaluation unit is usually connected at the output side both to a display unit and to a communication interface, via which the prepared measurement signals can be transmitted to the aforementioned control unit. The ongoing measuring values are displayed on the display unit. Furthermore, the display unit is often also used to set up and parameterize the measuring device. For this purpose, the measuring device is additionally provided with corresponding input options.

The display units are either integrated directly into the housing of the measuring device, detached from the housing of the measuring device but still mechanically connected to the measuring device or completely detached from the housing of the measuring device and only electronically connected.

Typically, the display unit consists of a housing which, depending on the design, can either be the housing of the measuring device or a separate housing for the display unit itself. This housing then comprises an opening for a display that can display various measurement and/or parameter data of the measuring device and is covered by a front panel. A sealing element is then arranged between the housing and the front panel, for which flat seals or O-rings, each made of an elastomer, are often used.

As the closest prior art DE 102012102948 A1 is to be considered, from which a housing equipped with a viewing window is known. The housing comprises a viewing window inserted into a recess in an outer wall of the housing, in which a surface of the viewing window pointing out of the housing has a curvature pointing outwards from the housing.

As further prior art DE 102012111662 A1 and DE 4304370 A1 are to be mentioned, from which it is respectively known to provide a conical taper at a housing opening and at a viewing window or glass ceramic cooking surface inserted therein. In the area of the taper, a correspondingly designed molded seal is arranged between the viewing window or glass ceramic cooking surface and the housing.

Special hygiene guidelines must be observed in process plants in the pharmaceutical or food industry. Here, ensuring a reliable, often automated cleaning process is of fundamental importance. Thus, the surfaces must be designed in such a way that dirt cannot accumulate or can be safely and easily cleaned off by the cleaning medium. Like the rest of the machines and system components, sensors should be able to be cleaned without residue in the shortest possible time, especially if they are installed in hygienic areas.

It is an object of the invention to propose a measuring device for process and automation technology that has a gap-free display unit, which, thus, is optimized from a hygiene point of view.

According to the invention, the object is achieved by a display unit with the features of claim 1 and a measuring device according to claim 10. Advantageous embodiments of the invention are provided in the subclaims.

According to the invention, the front panel at first comprises a peripheral recess at the edge, in which the sealing element is arranged and which is at least partially covered by the housing, so that the sealing element is at least partially fixed between the inside of the housing and the front panel, but a free space is nevertheless formed between the housing and the front panel.

Furthermore, the sealing element is designed as a molded seal with a bead-like main part and a seal lip, which is formed by two legs arranged at an angle to each other—preferably 90°—and has a shape that complements the contour of the recess in the front panel. Depending on the shape of the edge of the housing, this angle can be greatly flattened until it almost disappears when the indentation of the housing is minimized.

Here, the bead-like main part is arranged between the inside of the housing and the front panel to achieve a pressing or holding function for the front panel and the seal lip extends into the free space between the housing and the front panel to achieve a radial sealing effect. The sealing element preferably consists of an elastomer.

The two legs of the seal lip can either be of the same thickness or of different thicknesses, whereby in the latter case it is advantageous if the leg extending into the free space between the housing and the front panel has a continuously increasing or decreasing thickness. The latter further development has the advantage that this leg then extends wedge-like into the free space between the housing and the front panel.

According to the invention, the front panel is not aligned with the surface of the housing, but is set back slightly. Accordingly, the inner edge of the housing, which covers the recess of the front panel, has an embossed section of preferably 30° in the direction of the height of the front panel. This embossed section in the window area of the housing allows the molded seal clamped on the front panel to be ideally joined. When installed, the seal lip is pressed to the maximum at the uppermost corner in a quasi-linear area and thus closes the gap between the join partners in a very harmonious manner. The part of the seal lip that is visible on the outside then forms a hygienic, tangential transition between the embossed section at the housing and the top of the front panel in the pressed state. The housing is preferably produced by a deep-drawing process.

According to a further development of the invention, the sealing element consists of two different materials, so that the corresponding functional requirements for the bead-like main part and the seal lip can advantageously be taken into account with corresponding material properties, e.g. by different hardness or chemical resistance.

The core idea of the invention is that two independent functions are fulfilled with the special sealing element, namely the pressing or holding function for the front panel by the bead-like main part on the one hand and a gap filling and thus reliable sealing function by the seal lip on the other hand, and both areas are largely functionally decoupled from each other. Here, the sealing function of the seal lip is so reliable because the seal lip is in a defined position due to its two legs molded onto the bead-like main part and remains dimensionally and positionally stable despite chemical or thermal influences. The bead-like main part of the sealing element can also be used to achieve production-related vertical tolerance compensation and the seal lip can be used to achieve horizontal tolerance compensation.

In the following, the invention is explained in more detail based on exemplary embodiments with reference to the drawings.

The drawings schematically show:

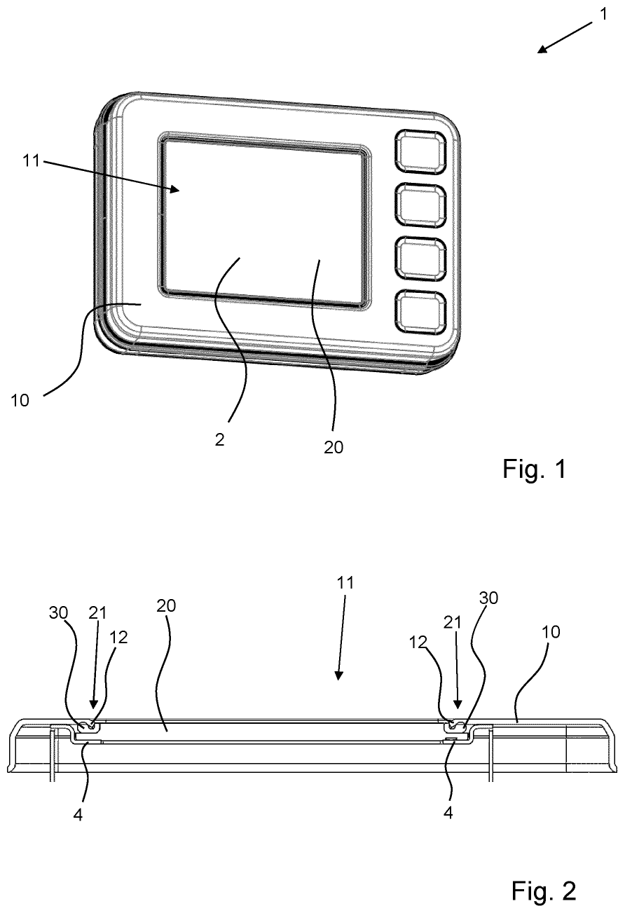

FIG. 1 an embodiment of a display unit according to the invention;

FIG. 2 a sectional view of a display unit according to the invention;

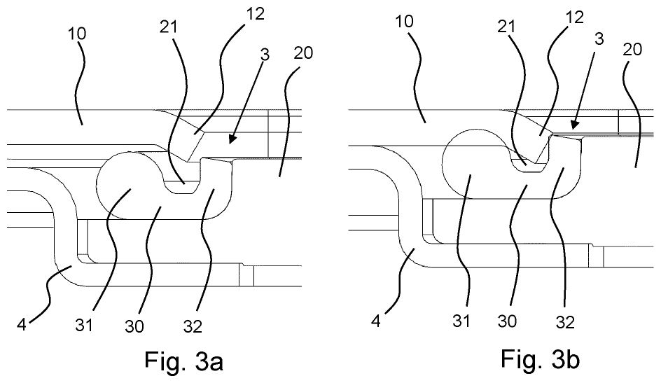

FIG. 3a a detailed view of the sectional view from FIG. 2 during joining; and

FIG. 3b a detailed view of the sectional view from FIG. 2 in the assembled state.

In the following description of the preferred embodiments, identical reference symbols denote identical or comparable components.

FIG. 1 shows an embodiment of a display unit 1 according to the invention, in this case in the form of a display unit 1 that is detached from the housing of the actual measuring device and mechanically and electronically connected to it. The measuring device is, for example, a magnetic-inductive flow meter. Similarly, an embodiment could be one in which the display unit 1 is completely detached from the housing of the measuring device and is only connected to it electronically. The invention also encompasses a third embodiment in which the display unit 1 is integrated directly into the housing of the measuring device.

The display unit 1 comprises a housing 10 which, depending on the embodiment, can either be the housing of the measuring device or a separate housing for the display unit 1 itself. This housing 10 then comprises an opening 11 for a display 2, which can display various measurement and/or parameter data of the measuring device and is covered by a front panel 20. Operating buttons for setting up and parameterize the measuring device are indicated on the right side.

FIG. 2 shows a sectional view through a display unit 1 according to the invention. The front panel 20 is arranged in the opening 11 of the housing 10. The front panel 20 has a peripheral recess 21 at the edge, in which a sealing element 30 is arranged. The recess 21 of the front panel 20 is partially covered by the housing 10, so that the sealing element 30 is fixed between the inside of the housing 10 and the front panel 20. A clasp 4 in the form of a clip-like housing part is also connected, preferably welded, to the housing 10. This clasp 4 has a double-angled shape in cross-section and the front panel 20 rests on the inner part. In this way, the sealing element 30 and the front panel 20 are clamped in a sandwich-like manner.

The front panel 20 is set back slightly from the surface of the housing 10. For this purpose, the inner edge of the housing 10 above the recess 21 of the front panel 20 has an embossed section 12 in the vertical direction of the front panel 20. The embossed section preferably extends under an angle of 30°.

FIGS. 3a and 3b each show a detailed view of the sectional view from FIG. 2, wherein FIG. 3a shows a situation during the joining process and FIG. 3b the finished, installed state.

The sealing element 30, designed as a molded seal, can be seen, which is arranged in the peripheral recess 21 at the edge of the front panel 20 and is preferably made of an elastomer. The sealing element 30 consists of a bead-like main part 31 and a seal lip 32. The seal lip 32 is formed by two legs arranged perpendicular to each other, i.e. at approximately 90°, and has a shape that complements the contour of the recess 21 of the front panel 20. Here, the bead-like main part 31 between the inner side of the housing 10 and the front panel 20 achieves axial support or pressing down of the front panel 20 into its defined position with force transmission and secondary sealing at the same time. In addition, tolerance compensation in the vertical direction is achieved by the bead-like main part 31 and in the horizontal direction by the seal lip 32. To achieve a radial sealing effect, the seal lip 32 extends into a free space 3, which is formed between the housing 10 and the front panel 20. After assembly, see FIG. 3b, maximum compression is achieved at the front, towards the outside or towards the medium, in a quasi-linear area.

As can be seen in particular from FIG. 3b, the free space 3 is not completely filled by the two legs of the seal lip 32, even in the finished, installed state. The remaining space now serves to ensure that the sealing element 30 can retract in the area of the seal lip 32 as a result of the influence of temperature, so that the sealing element 30 remains dimensionally and positionally stable in the area relevant for the sealing effect and ultimately the sealing function is not impaired.

FIGS. 3a and 3b each show an embodiment in which the two legs of the seal lip 32 are of equal thickness. Alternatively, it is also conceivable for the two legs to have different thicknesses. It is then advantageous if the leg extending into the free space between the housing and the front panel has a steadily decreasing thickness towards the outside or towards the top, so that it assumes a wedge shape. It is conceivable, for example, to provide a slope of approximately 20°. If the end face of the embossed section 12 has a slope deviating therefrom, e.g. a slope of 30° mentioned above, the advantage is achieved that the seal lip 32 is then arranged wedge-like in the free space 3 between the housing 10 and the front panel 20 and ensures maximum compression in the front area which is in contact with the media during assembly.

As can already be seen in FIG. 2, the front panel 20 is set back slightly from the surface of the housing 20. In this case, the inner edge of the housing 10 above the recess 21 of the front panel 20 has an embossed section 12 in the vertical direction of the front panel 20. This embossed section 12 in the window area of the housing 10 ideally joins the sealing element 30 clamped onto the front panel 20, as can be seen from the combined view of FIG. 3a and FIG. 3b. In the installed state, the seal lip 32 is pressed only at the uppermost corner and thus reliably closes the gap between the housing 10 and the front panel 20. In the pressed state, the part of the seal lip 32 that is visible from the outside then forms a hygienic, tangential transition between the embossed section 12 at the housing 10 and the upper side of the front panel 20, so that as a result a hygienic, gap-free seal between a preferably deep-drawn housing 10 and a display panel 20 is realized.

### LIST OF REFERENCE SYMBOLS

1 display unit
2 display
3 free space
4 clasp, clamp-like housing part
10 housing
11 opening
12 embossed section
20 front panel
21 recess
30 sealing element
31 bead-like main part
32 seal lip

1. A display unit (1) for a measuring device in process and automation technology, comprising a housing (10) with an opening (11) for a display (2) on which various measurement and/or parameter data of the measuring device can be displayed;
wherein the display (2) is covered by a front panel (20) and a sealing element (30) is arranged between the housing (10) and the front panel (20);
wherein the front panel (20) comprises a peripheral recess (21) at the edge, in which the sealing element (30) is arranged and which is at least partially covered by the housing (10), so that the sealing element (30) is at least partially fixed between the inner side of the housing (10) and the front panel (20) and a free space (3) is formed between the housing (10) and the front panel (20),
and in that the sealing element (30) is designed as a molded seal with a bead-like main part (31) and a seal lip (32), which is formed by two legs arranged at an angle to one another and has a shape complementary to the contour of the recess (21) of the front panel (20);
wherein the bead-like main part (31) is arranged between the inner side of the housing (10) and the front panel (20) to achieve a pressing or holding function for the front panel (20) and the seal lip (32) extends into the free space (3) between the housing (10) and the front panel (20) to achieve a radial sealing effect;
wherein the front panel (20) is set back relative to the surface of the housing (10) and the inner edge of the housing (10), which covers the recess (21) of the front panel (20), comprises an embossed section (12) vertical to the front panel (20).

2. The display unit (1) according to claim 1, wherein the embossed section (12) extends under an angle of 30°.

3. The display unit (1) according to claim 1,
wherein the housing (20) is produced by a deep-drawing process.

4. The display unit (1) according to claim 1,
wherein the two legs of the seal lip (32) are arranged at 90° to each other.

5. The display unit (1) according to claim 1,
wherein the two legs of the seal lip (32) are each of equal thickness.

6. The display unit (1) according to claim 1,
wherein the two legs of the seal lip (32) are of different thickness, wherein at least one of the two legs has a continuously increasing thickness.

7. The display unit (1) according to claim 1,
wherein the sealing element (30) comprises two different materials.

8. A measuring device for process and automation technology, comprising a display unit (1), wherein the display unit (1) is configured according to claim 1.

9. A measuring device for process and automation technology, comprising a display unit (1), wherein the display unit (1) is configured according to claim 2.

10. A measuring device for process and automation technology, comprising a display unit (1), wherein the display unit (1) is configured according to claim 3.

11. A measuring device for process and automation technology, comprising a display unit (1), wherein the display unit (1) is configured according to claim 4.

12. A measuring device for process and automation technology, comprising a display unit (1), wherein the display unit (1) is configured according to claim 5.

13. A measuring device for process and automation technology, comprising a display unit (1), wherein the display unit (1) is configured according to claim 6.

14. A measuring device for process and automation technology, comprising a display unit (1), wherein the display unit (1) is configured according to claim 7.
